(19) United States
(12) Patent Application Publication
(10) Pub. No.: US 2008/0081681 A1
(43) Pub. Date: Apr. 3, 2008

(54) HELICAL ROCK BEATER

(76) Inventor: Carl Vogt, Chokio, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/861,847

(22) Filed: Sep. 26, 2007

Related U.S. Application Data
(60) Provisional application No. 60/847,954, filed on Sep. 28, 2006.

(51) Int. Cl. A01F 12/00

(52) U.S. Cl. 460/105

(57) ABSTRACT

A rock beater includes a central shaft; a plurality of helical blades attached around the circumference of the central shaft; a plurality of gussets attached to the central shaft and the helical blades; and a pair of end caps in the form of disks attached to each end of the central shaft and the helical blades. A combine incorporating the rock beater is included. A method of using such rock beater is further included.

### REFERENCE TO RELATED APPLICATIONS

The present application claims the benefit of Provisional Application No. 60/847,954, filed Sep. 28, 2006, which is hereby incorporated by reference in its entirety.

### FIELD OF THE INVENTION

The present invention relates generally to a component of a grain harvester or combine. More particularly, the present invention relates to an improved rock beater that is constructed with blades in a helical configuration and a method for use of this apparatus.

### BACKGROUND OF THE INVENTION

For some time it has been known that mounting a cylindrical rock beater between the pick-up header and threshing section of a combine or grain harvester can improve the lifespan of the combine by reducing damage due to foreign objects, such as stones or rocks, entering the combine. Typically, a cylindrical rock beater is positioned perpendicular to the direction of the flow of the crop entering the combine. The rock beaters as shown in the prior art have straight horizontal blades to separate any rocks or stones from the incoming crops by beating them in a downward direction; forcing the rock out of the indented path of the harvested material.

Examples of typical rock beater designs include, Helm et al., U.S. Pat. No. 4,657,029, which discloses a rotating beater assembly and stone trap. Jones, U.S. Pat. No. 5,733,192 is directed to a rock beater with teeth that extend from a rotating cylinder. Both of these designs depict a beater portion of the assembly with a horizontal orientation that extends in a straight line from one end of a central cylinder to the other, as depicted in FIGS. 2-5. An example of this design can be found in the Case IH 2300 Series of grain harvesters, which are manufactured by the CNH America LLC. Meyers et al., U.S. Pat. No. 4,335,562 discloses a rock trap and beater assembly wherein the beaters do not extend the fill length of the central cylinder. However, the beaters are still in a straight, horizontal orientation.

The current drawback to these designs is the tendency for material to become clogged in the space between the rotating horizontal blades and the rock trap wear angle which the incoming material passes through as it is harvested. Because the blades of the prior art extend straight across the opening for harvested material the gap between the blades and the rock trap wear angle is continuously varying by the approximate length of the blade from the shaft on which it rotates. The helical blades of the present invention overcome this drawback by providing an opening between the rock beater and the rock trap wear angle that is allows for a more consistent flow of harvested material while the rock beater is rotating.

Additionally, a variety of alternative designs utilizing one or more methods of acoustically sensing the presence of a stone in the feederhouse of a combine and then ejecting it from the feederhouse have been utilized. Examples of these designs include U.S. Pat. Nos. 6,298,641 to Digman et al. and 3,675,660 to Girodat. However, these designs suffer from the disadvantage of also ejecting harvested material from the feederhouse when the stone is ejected. This process also runs the risk of the trap door becoming stuck in the open position.

Helical cylinders have been utilized in other fields. Examples include is U.S. Pat. Nos. 5,134,744 to Ji and 5,249,328 to Shin, which both disclose a helical beater-brush on the roller of a vacuum cleaner. In these cases the brush is used to pull material into the assembly. However, in the present invention the helical cylinder is employed to force unwanted objects out of the flow of desired material.

While these prior patents, all of which are herein incorporated by reference in their entirety, have suggested various improvements on the prior art, there remains a need to identify improved designs that allow for an increased flow of harvested material into the threshing area of the combine while reliably forcing any stones, rocks, or large foreign matter out of the combine. All of this needs to be accomplished while avoiding clogging the machine which requires an undesirable interruption in harvesting operations.

### SUMMARY OF THE INVENTION

The present invention is a rock beater including multiple rock beater sections or blades equally spaced around a rotating central shaft. Each blade is formed such that it possesses a helical shape as it extends along the length of the central shaft. The blades are mechanically attached to the center shaft along with triangular gussets which are periodically spaced along the length of the blade and attached to both the center shaft and the helical blades. The present invention is further a combine incorporating the rock beater. And, the present invention is further a method of using such rock beater.

The above summary of the invention is not intended to describe each illustrated embodiment or every implementation of the present invention. The Figures and the detailed description that follow more particularly exemplify these embodiments.

### BRIEF DESCRIPTION OF THE DRAWINGS

The invention can be more completely understood in consideration of the following detailed description of various embodiments of the invention in connection with the accompanying drawings, in which:

FIG. 1 is a photograph depicting the location of a typical rock beater in a combine.

FIG. 2 is a photograph of a rock beater that is typical example of the prior art in a first orientation.

FIG. 3 is a photograph of a rock beater that is typical example of the prior art in a second orientation.

FIG. 4 is a photograph of a rock beater that is typical example of the prior art in a third orientation.

FIG. 5 is a photograph of a rock beater that is typical example of the prior art in a fourth orientation.

FIG. 6 is an end view of the helical rock beater of the present invention in an assembled configuration.

FIG. 7 is a perspective view of the helical rock beater of the present invention in the assembled configuration.

FIG. 8 is a front view of the helical rock beater of the present invention in the assembled configuration.

FIG. 9 is another end view of the helical rock beater of the present invention in the assembled configuration.

FIG. 10 is a side view of the helical rock beater of the present invention in the assembled configuration.

FIG. 11 is a front view of the helical rock beater of the present invention in the assembled configuration.

FIG. 12 is a side view of the helical rock beater of the present invention in the assembled configuration.

FIG. 13 is another perspective view of the helical rock beater of the present invention in the assembled configuration.

FIG. 14 is a frontal view of the helical rock beater of the present invention with serrated blades in the assembled configuration.

FIG. 15 is a frontal view of the helical rock beater of the present invention with serrated blades in the assembled configuration.

FIG. 16 is a perspective view of the helical rock beater of the present invention with serrated blades in the assembled configuration.

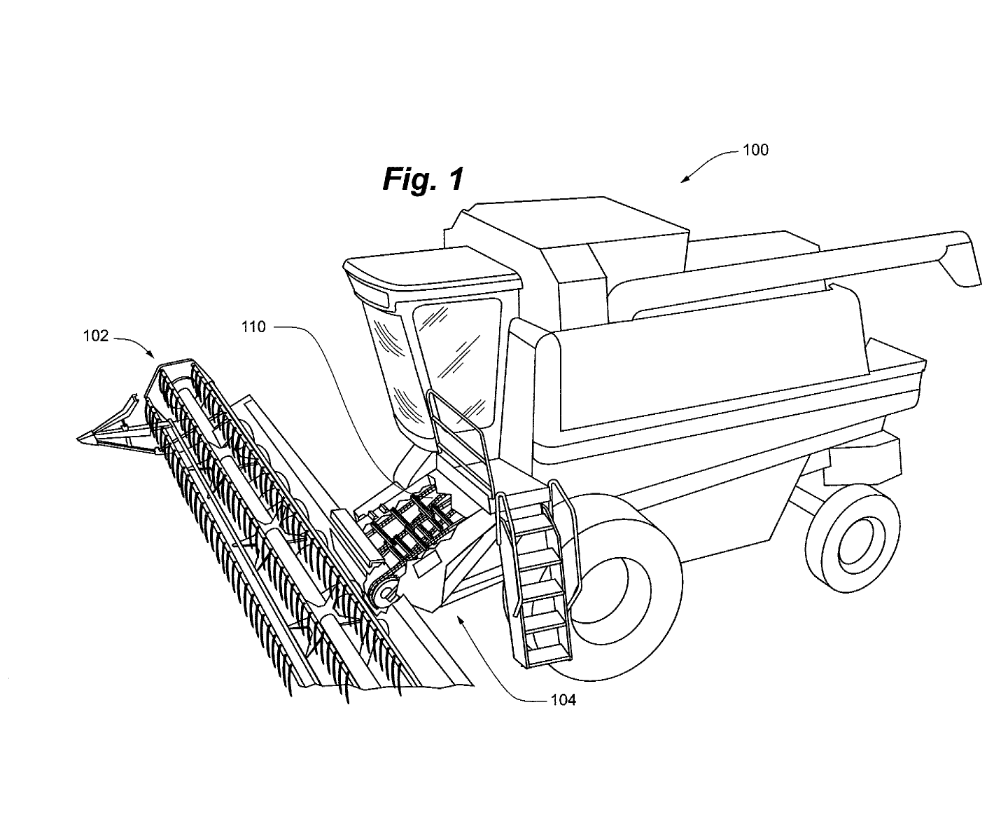

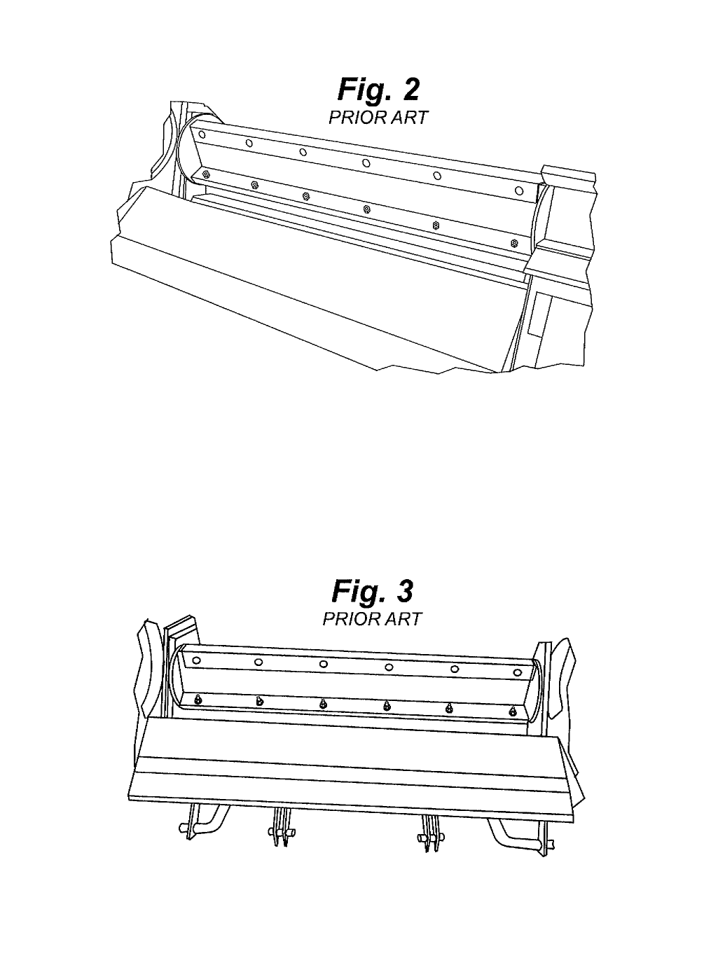

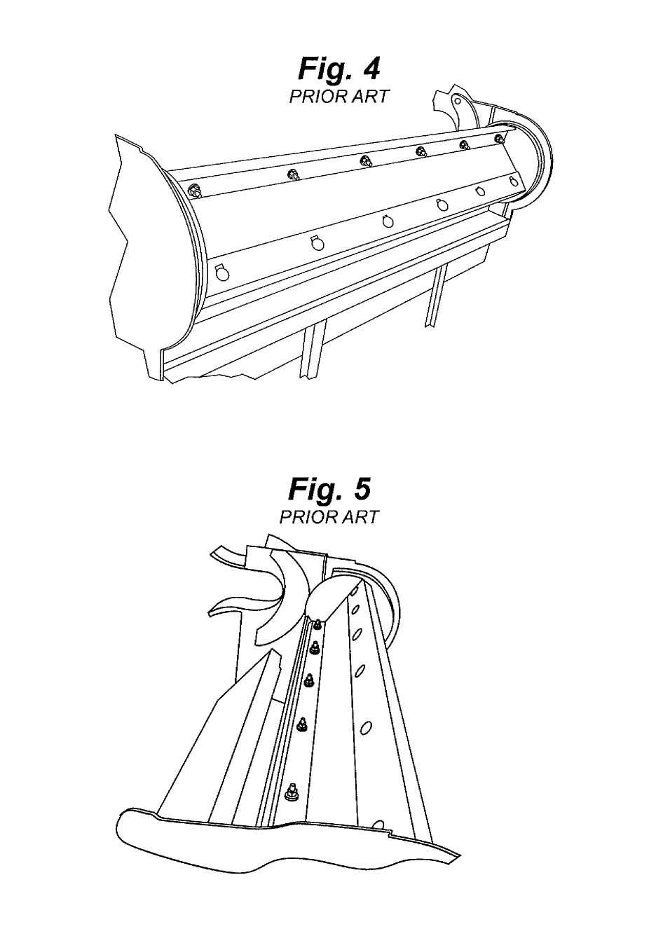

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

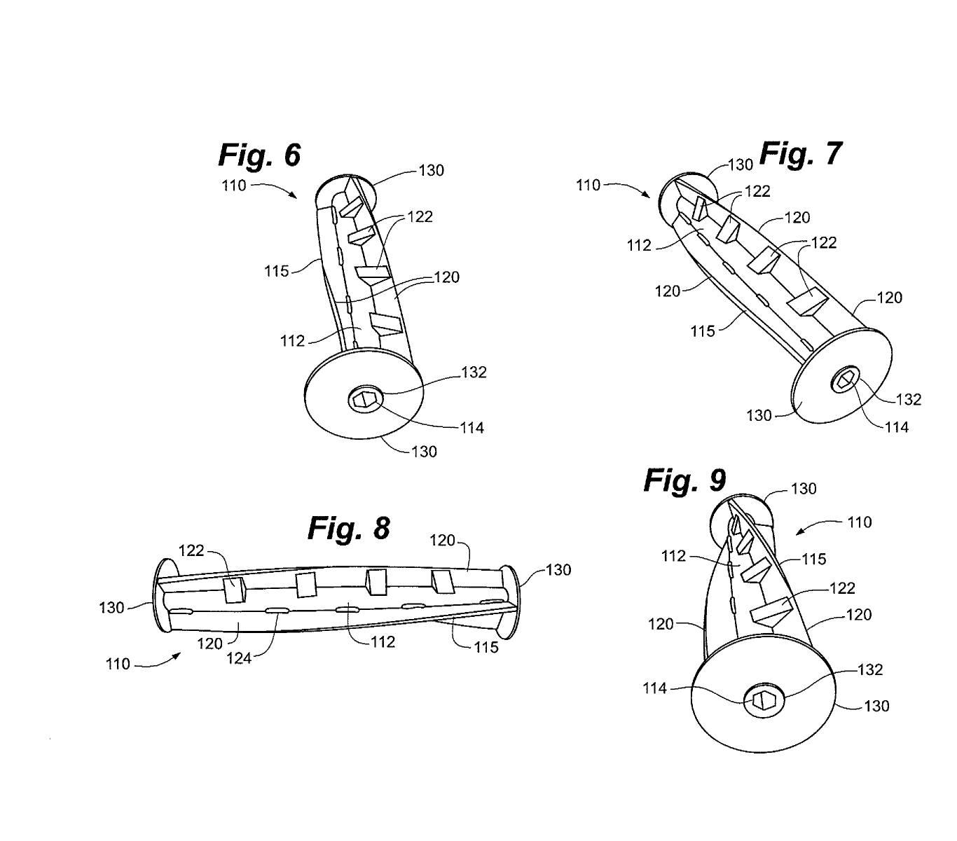

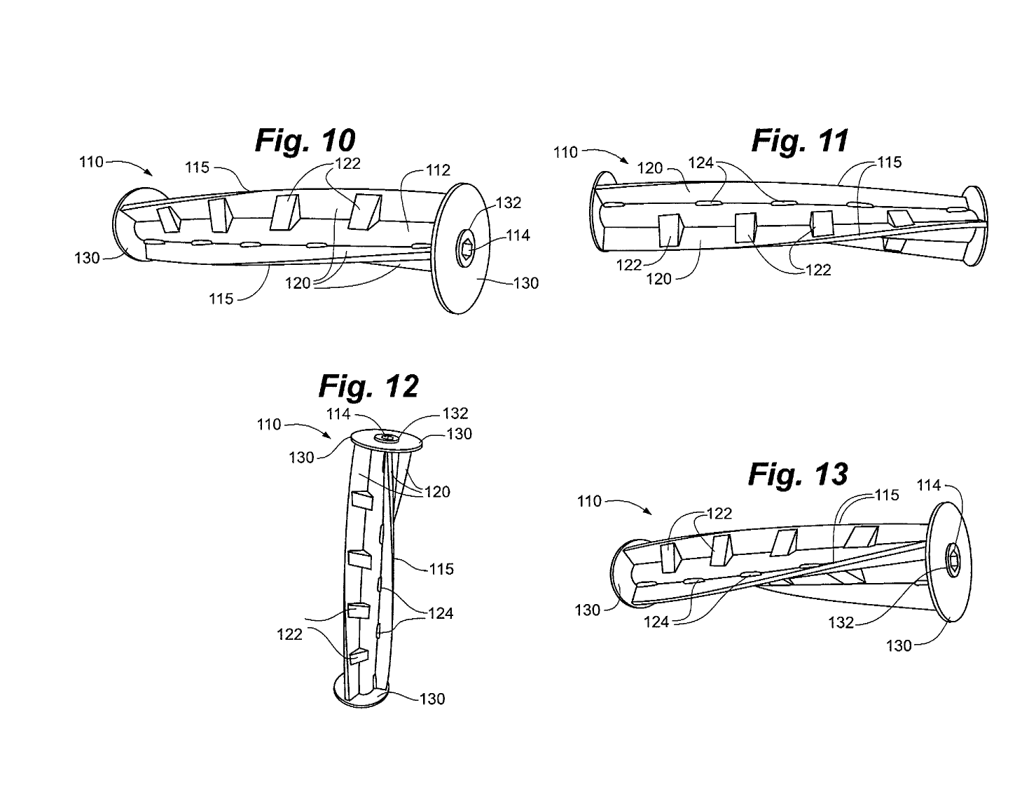

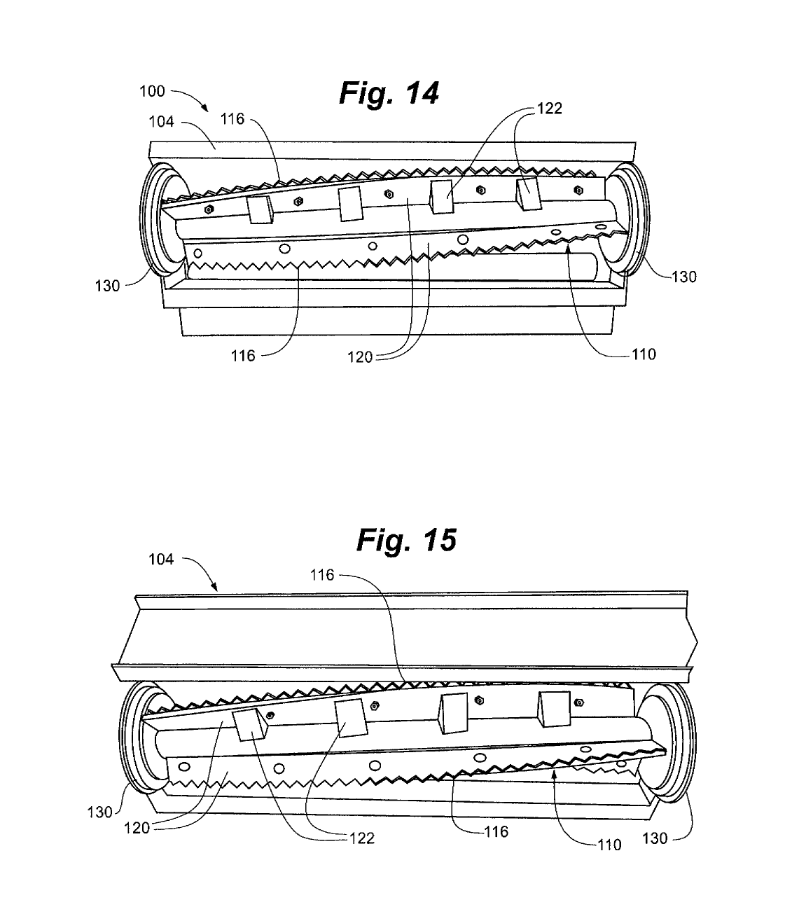

The present invention is a rock beater with helical blades, as most clearly illustrated at 110 in FIGS. 6-13. The helical rock beater 110 includes a central shaft 112 which has a thick wall, heavy duty tube, preferably with a two and three-quarter inch inside diameter (ID) and a three and one-half inch outside diameter (OD). The length of the central shaft 112 should be sized to match the width of the intake portion 104 of the combine 100 where the rock beater 110 will be installed. In one proposed embodiment this length is thirty-four and one-half inches from end to end.

The inside bore of the tube forming the central shaft 112 is adapted to form a hex socket 114 in order to receive a hex shaft which will provide the rotational power from the combine 100 to the rock beater 110. Alternate embodiments include physical attachment with the use of spline shafts, keyed shafts, or other appropriate devices for transferring torque to the rock beater 110.

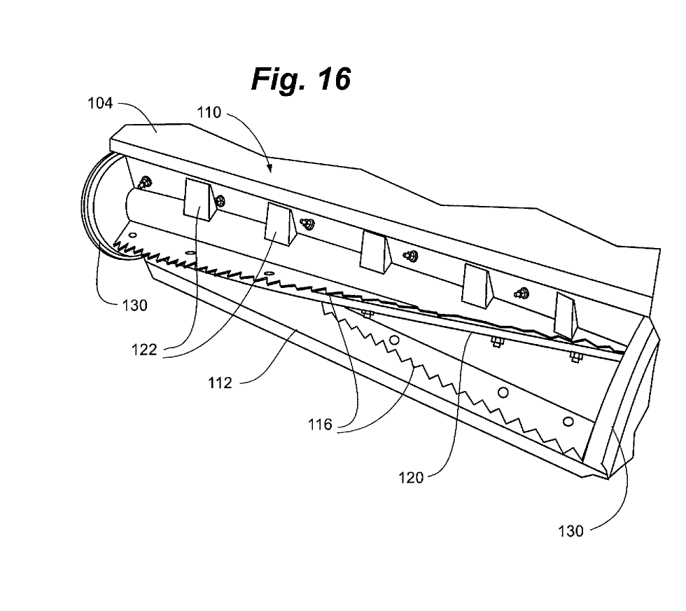

The helical rock beater 110 has multiple blades 120 attached to the central shaft 112 at a right angle. These blades 120 are formed into a helical shape as they extend along the length of the central shaft 112. In one embodiment of the invention the blades 120 are formed from one-half inch thick by two inch wide rectangular steel bars. These bars can be physically attached to the central shaft 112 by welding or other appropriate means. It may also be desirable for the blade margin of each of the blades 120 facing away from the central shaft 112 to be serrated, rather than the continuous blade margin 115 of FIGS. 6-9. Such serrations are depicted at 116 in FIGS. 15-16.

A solid disk 130 with a central hole 132 can be attached to each end of the central shaft 112 and helical blades 120 in order to provide additional physical stability to the rock beater assembly 110. The radius of the disk 130 should be equal to the distance from the center of the central shaft 112 to the outer edge of an attached blade 120. The diameter of the central hole 132 in the disk 130 should be equal to the outer diameter of the central shaft 112 such that the disk 132 can be fitted over the end of the central shaft 112 and not interfere with the attachment of a hex shaft into the hex socket 114.

Along the length of the intersection of the central shaft 112 and the helical blades 120 a plurality of gussets 122 are physically attached to both the central shaft 112 and the helical blades 120 in order to provide strength to the assembly and extend its useful life. In one embodiment the gussets 122 are physically attached to both the central shaft 112 and the helical blades 120 by welding. Additional welds 124 are employed on the side of the helical blades 120 that is opposite the gusseted side of the helical blade 120. In another possible embodiment the gussets 122 are attached with mechanical fasteners such as rivets or threaded bolts.

In another potential embodiment the gussets 122 can be replaced with brackets that are removably attached to the central shaft 112 and are also removably attached to the helical blades 120. This configuration allows for the replacement of the individual helical blades 120 or brackets should they become worn or damaged. This embodiment can also allow for the helical blades 120 to formed from a plurality of blade sections such that individual sections of the helical blade 120 can be replaced. This embodiment would allow for the helical blade to be formed without having to bend or shape a long rectangular steel bar into the helical shape, instead smaller, straight sections of steel bar would be attached to the central shaft 112 such that they formed a helical blade 120.

In yet another potential embodiment a plurality of prongs can be physically attached to the central shaft 112 of the helical rock beater 110. The prongs would follow the helical configuration of the blades 120 of the earlier embodiment. Preferably, the prongs would extend from the central shaft 112 approximately two inches, and be spaced no more than one inch apart along the length of the central shaft 112. Each individual prong can be physically attached to the central shaft 112 by welding or other permanent attachment, or the use of a bracket to removably attach the prong to the central shaft 112 can be employed to allow individual prongs to be easily replaced.

In all embodiments of the rock beater concept disclosed here it is important that the rock beater 110 be evenly balanced around the central rotating axis. This balance is desirable as it reduces the vibration that may be caused by the operation of the rock beater 110. Typically the rock beater 110 will rotate at a speed between four-hundred and eight-hundred revolutions per minute (RPM), depending on the type of crop being harvested and the forward ground speed of the combine 100. The proper balance of the rock beater is achieved by uniformly spacing each of the blades 120, gussets 122, and welds 124 around the axis of the central shaft 112. Additionally, it may be desirable to attach small weights at various locations around the central shaft 112 during the construction of the rock beater 110 to ensure that the proper balance is achieved.

It is contemplated that features disclosed in this application, as well as those described in the above applications incorporated by reference, can be mixed and matched to suit particular circumstances. Various other modifications and changes will be apparent to those of ordinary skill. This application is intended to cover adaptations or variations of the present subject matter. Therefore, it is intended that the invention be defined by the attached claims and their legal equivalents.

1. A rock beater comprising:
a central shaft;
a plurality of blades attached to the central shaft; and
the plurality of blades having a helical shape.

2. The rock beater of claim 1, further comprising:
a plurality of gussets;
the gussets being equally spaced along the length of the central shaft at the intersection of the central shaft and the individual blades;
and the gussets being physically attached to both the central shaft and an individual blade.

3. The rock beater of claim 1, further comprising:
a pair of disks;
the disks being physically attached to opposite ends of the central shaft and the plurality of blades; and
each disk having a centrally located hole of sufficient size to allow access to the interior bore of the central shaft.

4. The rock beater of claim 1 wherein the height of the plurality of blades from the central shaft are adjustable, such that they can be fixed at various lengths.

5. The rock beater of claim 1 wherein the plurality of blades attached to the central shaft have a serrated edge facing away from the central shaft.

6. The rock beater of claim 1 wherein the plurality of blades attached to the central shaft are comprised of a plurality of blade elements that form a helical shaped blade.

7. The rock beater of claim 1 wherein the plurality of blades have a continuous blade margin.

8. The rock beater of claim 1 wherein the plurality of blades have a serrated blade margin.

9. A rock beater comprising:
a central shaft;
a plurality of prongs attached to the central shaft;
the plurality of prongs being equally spaced around the circumference of the central shaft; and
the plurality of prongs forming a helical shape as they are positioned along the length of the central shaft.

10. A method wherein a rotating rock beater with a plurality of helical blades is used to prevent undesirable foreign objects from entering into a combine.

11. The method of claim 10 wherein the rock beater is located between the header portion and the threshing area of a combine.

12. The method of claim 10 wherein the rock beater rotates at a variable rate between four-hundred and eight-hundred revolutions per minute.

13. The method of claim 10 including forming the plurality of helical blades with a continuous blade margin.

14. The method of claim 1 including forming the plurality of helical blades with a serrated blade margin.

15. A combine having a rock beater comprising:
a central shaft;
a plurality of blades attached to the central shaft; and
the plurality of blades having a helical shape.

16. The combine of claim 15, further comprising:
a plurality of gussets;
the gussets being equally spaced along the length of the central shaft at the intersection of the central shaft and the individual blades;
and the gussets being physically attached to both the central shaft and an individual blade.

17. The combine of claim 15, further comprising:
a pair of disks;
the disks being physically attached to opposite ends of the central shaft and the plurality of blades; and
each disk having a centrally located hole of sufficient size to allow access to the interior bore of the central shaft.

18. The combine of claim 15 wherein the height of the plurality of blades from the central shaft are adjustable, such that they can be fixed at various lengths.

19. The combine of claim 15 wherein the plurality of blades attached to the central shaft have a serrated edge facing away from the central shaft.

20. The combine of claim 15 wherein the plurality of blades attached to the central shaft are comprised of a plurality of blade elements that form a helical shaped blade.

21. The combine of claim 15 wherein the plurality of blades have a continuous blade margin.

22. The combine of claim 15 wherein the plurality of blades have a serrated blade margin.
